(19) United States
(12) Patent Application Publication
(10) Pub. No.: US 2022/0252224 A1
(43) Pub. Date: Aug. 11, 2022

(54) TAPERED VAPOR PLUG

(71) Applicant: Cryoport, Inc., Brentwood, TN (US)

(72) Inventors: Ben Lee, Corona, CA (US); Bret Bollinger, Yorba Linda, CA (US)

(73) Assignee: Cryoport, Inc., Brentwood, TN (US)

(21) Appl. No.: 17/665,183

(22) Filed: Feb. 4, 2022

Related U.S. Application Data
(60) Provisional application No. 63/146,372, filed on Feb. 5, 2021.

(51) Int. Cl. F17C 13/06; F17C 3/08

(52) U.S. Cl. CPC F17C 13/06; F17C 2270/0509; F17C 2205/0311; F17C 3/08

(57) ABSTRACT

Methods, systems, devices and/or apparatuses for a vapor plug. The vapor plug includes a vapor plug cover or lid. The vapor plug cover or lid is configured to cover an opening of a container. The vapor plug includes a neck. The neck has a first end and a second end that is configured to be inserted into the opening of the container. The first end has a first diameter and the second end has a second diameter that is less than the first diameter.

### CROSS REFERENCE TO RELATED APPLICATION

This application claims the benefit of U.S. Provisional Patent Application No. 63/146,372, filed Feb. 5, 2021, which is incorporated by reference herein in its entirety.

### TECHNICAL FIELD

This specification relates to a system, device or apparatus for plugging or partially sealing a cryogenic device that stores and/or transports a liquid or gas under cryogenic temperatures.

### BACKGROUND

Lab technicians, scientists, medical professionals, such as doctors or nurses, and other technicians may cryogenically store and transport material to various facilities, such as hospitals, labs and research facilities. When transporting the material at a cryogenic temperature, the technicians and/or professionals store the material in a dry vapor shipper. The dry vapor shipper is a vacuum insulated container that is used to transport the material. The dry vapor shipper may be a dewar that has an inner vessel with a thin-walled neck tube and an outer vessel. The inner wall of the inner vessel may have an absorbent material, such as a liquid or a gas. These dewars use the absorbent material to hold liquid nitrogen while trapping the vapors and retaining the extreme cold temperatures at approximately −195° C. The dewar has an internal chamber for loading product. In order to retain the cold temperatures, an apparatus, such as a vapor plug, is used to slow the escape of vapor gases. The vapor plug may act like a cork to partially seal an opening of the dewar. The vapor plug reduces the escape of vapors but does not create a seal. If the vapor plug were to seal the opening, this would create a dangerous pressurized vessel.

Normally, a vapor plug is designed using an insulation material made of polystyrene due to its effective insulation properties. However, moisture can build up during the cycling from low temperatures to ambient room temperatures, which may cause the vapor plug to freeze to an inner wall of the vessel.

Accordingly, there is a need for a system, device or apparatus that reduces the evaporation of the gas or liquid and equalizes the pressure within the dewar without freezing to an inner wall of the vessel.

### SUMMARY

In general, one aspect of the subject matter described in this specification is embodied in a vapor plug. The vapor plug includes a vapor plug cover or lid. The vapor plug cover or lid is configured to cover an opening of a container. The vapor plug includes a neck. The neck has a first end and a second end that is configured to be inserted into the opening of the container. The first end has a first diameter and the second end has a second diameter that is less than the first diameter.

These and other embodiment may optionally include one or more of the following features. The second end may be gradually tapered inward toward a center of the neck from the first end. This may result in the second end having the second diameter that is less than the first diameter. The neck may have two or more cylindrical portions. The two or more cylindrical portions may include a first cylindrical portion and a second cylindrical portion. The second cylindrical portion may be adjacent to the first cylindrical portion to form a step-like or tiered structure.

The vapor plug may include a handle. The handle may be coupled to the neck. The handle may be configured to allow ease of access to remove or insert the vapor plug into the opening of the container. The handle may be configured to be inserted through an opening in the vapor plug cover or lid into an opening or a recess within the neck to couple the handle with the neck. The vapor plug may include a hydrophobic liner. The hydrophobic liner may be shaped and sized to fit around the neck. The hydrophobic liner may be configured to receive the neck within. The hydrophobic liner may have a first end with a first circumference and a second end with a second circumference. The first circumference of the first end of the hydrophobic liner may be greater than a first circumference of the first end of the neck and tightly fit around the first end of the neck. The second circumference of the second end of the hydrophobic liner may be less than the first circumference of the first end of the hydrophobic liner.

The vapor plug may include a gasket. The gasket may be positioned underneath the vapor plug cover. The vapor plug may include an O-ring. The O-ring may be positioned in between the gasket and the neck. The gasket and the O-ring may be configured to prevent leakage between the vapor plug cover and the neck when joined together.

In another aspect, the subject matter may be embodied in a vapor plug. The vapor plug includes a vapor plug cover. The vapor plug cover may be configured to cover an opening of a container. The vapor plug includes a tapered neck. The tapered neck has a first end and a second end that is opposite the first end. The second end is configured to be inserted into the opening of the container. The first end has a first circumference and the second end has a second circumference that is less than the first circumference. The vapor plug includes a hydrophobic liner that is shaped and sized to fit around the neck and configured to receive the neck within.

In another aspect, the subject matter may be embodied in a tapered vapor plug. The tapered vapor plug includes a vapor plug cover. The vapor plug cover is configured to cover an opening of a dewar. The tapered vapor plug includes a tapered neck. The tapered neck has a proximal end coupled to the vapor plug cover and a tapered distal end that is configured to be inserted into the opening of the dewar. The tapered neck has a shape of an inverted frustum of a cone.

In another aspect, a method is provided. The method may include inserting a neck of a vapor plug into an opening of a container. The neck may be tapered, or may be stepped as disclosed variously herein. For instance, the neck may be the tapered neck having a first end and a second end, the first end having a first diameter and the second end having a second diameter that is less than the first diameter. The method may include covering the opening of the container by a vapor plug cover adjacent to a first end of the vapor plug. The method may also include sealing the container by the combination of the neck inserted into the opening of the container and the vapor plug cover covering the opening. Sealing the container may also include receiving between the neck and the opening of the container a hydrophobic liner shaped and sized to fit around the neck. Sealing the container mas include positioning a gasket underneath the vapor plug cover and an O-ring between the gasket and the neck of the of the vapor plug.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the following illustrative figures. In the following figures, like reference numbers refer to similar elements and steps throughout the figures.

FIG. 1A illustrates an example of a vapor plug that has a tapered end in accordance with various embodiments;

FIG. 1B illustrates a side perspective view of the tapered vapor plug of FIG. 1A according to various exemplary embodiments;

FIG. 2 illustrates the tapered vapor plug of FIGS. 1A and 1B inserted into a dewar according to various exemplary embodiments;

FIG. 3 illustrates an exploded view of the tapered vapor plug of FIGS. 1A and 1B according to various exemplary embodiments;

FIG. 4A illustrates an example a vapor plug that has a step-like or tiered structure according to various exemplary embodiments;

FIG. 4B illustrates a side perspective view of the step-like or tiered vapor plug according to various exemplary embodiments; and

FIG. 5 illustrates a method for sealing a container using a vapor plug according to various exemplary embodiments.

### DETAILED DESCRIPTION

Disclosed herein are systems, devices and/or methods for plugging or partially sealing a cryogenic device, such as a dewar, that stores and/or transports a liquid or gas under cryogenic temperatures. A vapor plug partially seals an inner vessel of the dewar. The dewar may be a double-walled vacuum insulated container that is used to transport commodities at cryogenic temperatures. The dewar may have an inner wall that is lined with an absorbent material and an outer wall, which forms an inner vessel and an outer vessel. The inner vessel of the dewar may have a neck portion. The neck portion may have an opening that receives the material and stores the material in the inner vessel. The absorbent material may be a liquid or gas.

The vapor plug may act like a cork to partially seal the opening and reduce the amount of liquid or gas that evaporates, while also equalizing the pressure within the dewar so that pressure does not build up within the dewar. By reducing the amount of liquid or gas that evaporates, the vapor plug also minimizes the amount of warm air that is pulled in to replace the evaporated liquid or gas, which prolongs the amount of time that the dewar can maintain the cryogenic temperatures.

Vapor plugs may be constructed with an insulating material such as polystyrene. To minimize heat loss, a gap between the interior chamber of the dewar and the insulating material may be as small as possible. Consequently, moisture may form and freeze along the neck of vapor plug. And, when the vapor plug is cylindrically-shaped and has a straight wall that is very close to the interior chamber, the moisture that forms and freezes along the neck of the vapor plug and/or the interior chamber may cause the vapor plug to freeze to the interior chamber. A tapered vapor plug with a frusto-conical neck, however, may prevent and/or reduce the likelihood that the vapor plug freezes to the interior chamber.

Since there is a temperature gradient where the top of the vapor plug is close to or at ambient temperature and the bottom of the vapor plug is at or near cryogenic temperatures due to its proximity to the liquid nitrogen within the payload area of the dewar, moisture is more likely to condense and freeze along the distal or bottom portion. A tapered vapor plug has a larger clearance or gap at the distal portion of the vapor plug relative to the wall of the interior chamber that results from the shape of the neck of the vapor plug. This prevents and/or reduces a likelihood that the vapor plug will freeze to the wall of the interior chamber or payload area of the dewar, which allows the vapor plug to be removed. The vapor plug may have an inverted frustoconical-shape or other tapered end so that there is a larger gap at the end of the vapor plug that resides within the neck or payload area of the dewar when the vapor plug is inserted than the opposite end that is proximal to the opening of the dewar while maintaining the nitrogen evaporation rate.

Other benefits and advantages include the use of a vapor plug with a step-like or tiered structure instead of the inverted frustoconical-shape or the other tapered end. The step-like or tiered structure, similarly, has one end that is inserted into opening of the cavity of the dewar and another end that is coupled to the vapor plug cover or lid. The one end that is inserted into the opening of the cavity of the dewar may have a circumference that is less than the circumference of the other end that is coupled to the vapor plug cover or lid. Since the one end that is inserted into the opening of the cavity of the dewar has a smaller circumference than the other end, there is a larger gap or clearance between the one end and the interior chamber of the dewar to reduce the likelihood that the vapor plug freezes with the interior chamber of the dewar while maintaining the nitrogen evaporation rate.

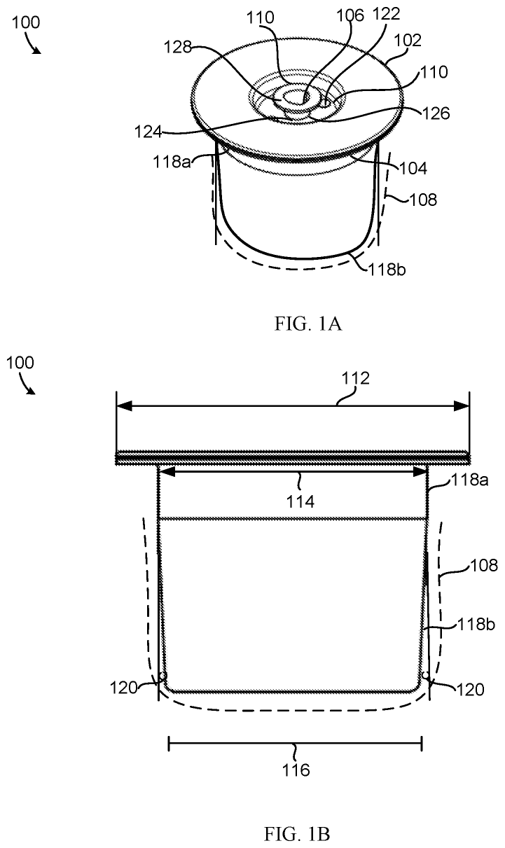

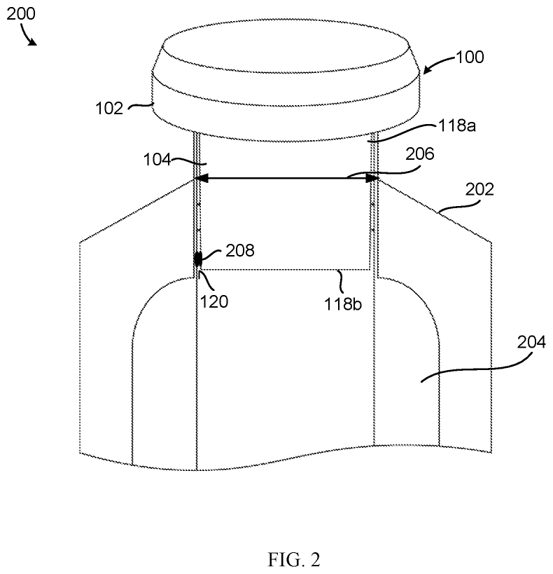

FIGS. 1A-1B show a vapor plug 100 in an exemplary embodiment. FIG. 1A shows an exterior view of the vapor plug 100. FIG. 1B shows a side perspective view of the vapor plug 100. The vapor plug 100 reduces evaporation of a liquid or gas in a dewar 202 when the vapor plug 100 is inserted into an opening of the dewar 202, as shown in FIG. 2 for example. The vapor plug 100 may partially seal the dewar 202. That is, the vapor plug 100 allows the liquid or gas to escape the dewar 202 to equalize the pressure within the dewar 202, but may also, obstruct and/or reduce the amount of liquid or gas that escapes to limit evaporation and limit warm air from entering into the dewar 202. This maintains the cryogenic temperatures within the dewar 202 to allow for continued cryogenic storage of the material stored within the dewar 202.

In various embodiments, the vapor plug 100 is removable. Specifically, the vapor plug 100 may be inserted into an opening of the dewar 202 to partially seal and/or limit access to a cavity 204 of the dewar 202. The vapor plug 100 may be removed from the cavity 204 of the dewar 202 to allow liquid and/or gas to escape from the cavity 204 of the dewar 202.

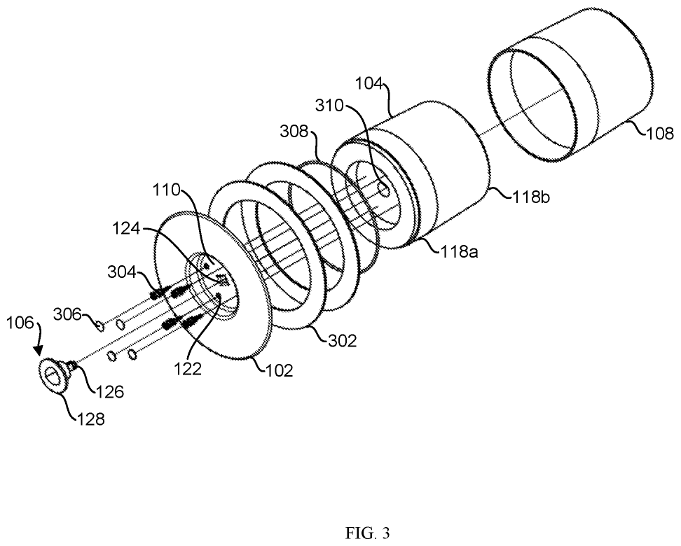

The vapor plug 100 has a vapor plug cover 102 and a neck 104. The vapor plug 100 has a handle 106, a liner 108 and other components within to form the vapor plug 100. The other components may include one or more gaskets 302, a liner 108, one or more anchors or fasteners 304, one or more labels 306 and/or an O-ring 308, as shown in FIG. 3 for example. The vapor plug 100 may be made from a single component, such as a unitary interconnected or integral piece, or multiple components that are interconnected, such as using one or more fasteners.

The vapor plug cover 102 may be a lid and/or may be cylindrically or circularly shaped. The vapor plug cover 102 may have a recess 110 that is positioned within the center of the vapor plug cover 102. The recess 110 may have one or more fastener openings 122 and/or a central handle opening 124. The one or more fastener openings 122 may be positioned within different quadrants of the recess 110 and may receive one or more anchors or fasteners 304 to couple the various components of the vapor plug 100 together. The central handle opening 124 may be positioned in the center of the recess 110 and receive a distal portion 126 of the handle 106 to couple the handle 106 with the neck 104.

Referring now to aspects of FIGS. 1A-B but with occasional reference also to FIG. 2, the vapor plug cover 102 may have a circumference and a plug diameter 112 that is greater than the circumference and first diameter 114 of the neck 104. The circumference and the plug diameter 112 may be greater than the circumference and dewar opening diameter 206 (FIG. 2) of the opening of the dewar 202 (FIG. 2) so that the vapor plug cover 102 covers the opening of the dewar 202 (FIG. 2).

The vapor plug cover 102 may have or be coupled to a handle 106. The handle 106 allows for ease of access to remove or insert the vapor plug 100 into the opening of the dewar 202 to partially seal the cavity 204 of the dewar 202, as shown in FIG. 2 for example. The handle 106 may have a proximal portion 128 that is shaped as a ring or other polygon and a distal portion 126 that is inserted into the recess 110 of the vapor plug cover 102 and through various other components to couple with a recess 310 within the neck 104. The handle 106 may be coupled to the vapor plug cover 102 and the neck 104 in a snap-fit arrangement. The proximal portion 128 may be shaped to allow for a user to easily grasp the handle 106 so that the user may lift or otherwise remove the vapor plug 100 from the opening of the dewar 202. The distal portion 126 may be pegged-shaped, such as a square, rectangular, hexagonal or polygonal-shaped peg so that the distal portion 126 may be fit and/or inserted into the recess 310 within the neck 104 via the central handle opening 124 of the vapor plug cover 102.

The handle 106 may be positioned within the recess 110 and fastened, connected or otherwise coupled to the vapor plug cover 102 and/or the neck 104. The handle 106 may be inserted into the central handle opening 124 of the vapor plug cover 102 into the recess within the neck 104 to couple the handle 106, the vapor plug cover 102 and/or the neck 104. FIG. 3 shows an exploded view of the vapor plug 100 and the interconnection of the vapor plug cover 102, the neck 104, the handle 106, the liner 108 and/or the other components of the vapor plug 100.

The vapor plug 100 may include one or more anchors or fasteners 304. The one or more anchors or fasteners 304 may be inserted into the one or more fastener openings 122. When the one or more anchors or fasteners 304 are inserted into the one or more fastener openings 122 and fastened, coupled or connected to the neck 104, the one or more anchors or fasteners 304 may anchor or fasten the vapor plug cover 102 to the neck 104.

The vapor plug 100 may include one or more labels 306. The one or more labels 306 may be positioned or placed on top of the one or more anchors or fasteners 304 when the one or more anchors or fasteners 304 are inserted into the one or more fastener openings 122 to couple the vapor plug cover 102 to the neck 104. The one or more labels 306 may be used to conceal the one or more fasteners 304 and to prevent moisture or other environmental variables from entering the one or more fastener openings 122.

The vapor plug 100 may include one or more gaskets 302 and/or an O-ring 308. The one or more gaskets 302 and/or the O-ring 308 may be positioned between the vapor plug cover 102 and the neck 104. The one or more gaskets 302 may be shaped along the circumferential perimeter of the vapor plug cover 102 and/or the neck 104 and may be positioned between the vapor plug cover 102 and the neck 104. The one or more gaskets 302 fills the space in between the vapor plug cover 102 and the neck 104 when the vapor plug cover 102 is positioned on top of the neck 104. The one or more gaskets 302 may be made from rubber, silicone, fiberglass, polytetrafluoroethylene, a plastic or elastic polymer or other pliable material, which may be compressible and suitable for a wide range of pressures and/or temperatures.

The vapor plug 100 may include an O-ring 308. The O-ring 308 may be a mechanical gasket made from an elastomer and be designed to be seated within a groove along the circumference of the neck 104. The O-ring may be positioned in between the one or more gaskets 302 and the neck 104. When the handle 106 is inserted into the central handle opening 124 of the vapor plug cover 102 and inserted within the recess 310 of the neck 104 to couple the vapor plug cover 102 with the neck 104, the vapor plug cover 102 and the neck 104 are compressed together with the one or more gaskets 302 and the O-ring in between. This forms a mechanical seal to prevent leakage between the vapor plug cover 102 and the neck 104 when joined together

Returning specific focus to FIGS. 1A and 1B, the vapor plug 100 includes a neck 104. The neck 104 may be cylindrically-shaped and inserted into the opening of the dewar 202 (FIG. 2) and may be made from a polystyrene material. The neck 104 may have a first end 118a and a second end 118b that is opposite the first end 118a. The first end 118a may be coupled to the vapor plug cover 102 and proximal to the opening of the dewar 202 (FIG. 2). The second end 118b may be inserted into the cavity 204 (FIG. 2) of the dewar 202 (FIG. 2) via the opening of the dewar 202 (FIG. 2). The second end 118b may reside within the neck of the dewar 202 (FIG. 2) when inserted into the opening of the dewar 202 (FIG. 2).

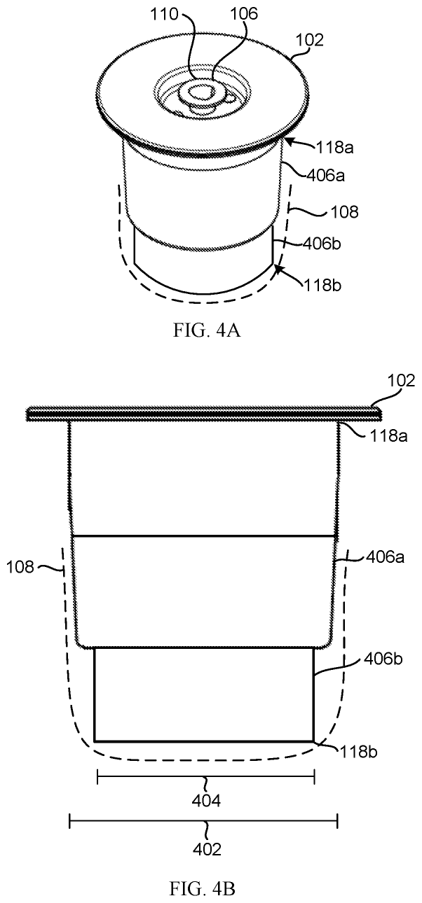

The first end 118a and the second end 118b may have different diameters. The first end 118a may have a first diameter 114 and/or a circumference that is greater than the second diameter 116 and/or the circumference of the second end 118b. For example, the vapor plug 100 may be a tapered vapor plug that has a neck with a tapered second end 118b that is inserted into the opening of the dewar 202 (FIG. 2), as shown in FIGS. 1A-1B for example. The second end 118b may be angled and gradually tapered inward toward the center of the neck 104 from the first end 118a to form an inverted frustoconical shape. The taper may begin at a point where loss due to thermal insulation is equivalent to the straight wall design and the surface temperature of the vapor plug 100 is warmer than the freezing point of water. This results in the second end 118b having the second diameter 116 and/or the circumference that is less than the first diameter 114 and/or the circumference of the first end 118a. Moreover, the diameter of the neck gradually decreases from the first end 118a to the second end 118b as the neck tapers or angles inward to form the inverted frustoconical shape. Since the temperature range at the first end 118a is greater than the temperature range at the second end 118b, which is closest to the cavity 204 (FIG. 2) of the dewar 202 (FIG. 2), the gap between the neck 104 and the wall of the dewar 202 (FIG. 2) at the first end 118a may be less than the gap at the second end 118b. The amount of the angle may be dependent on the temperature within the cavity 204 (FIG. 2) of the dewar 202 (FIG. 2). As the temperature within the cavity 204 (FIG. 2) of the dewar 202 (FIG. 2)is coldest, the second end 118b may be tapered at a greater angle than the first end 118a to increase the clearance or gap between the neck 104 and the interior wall of the dewar 202 (FIG. 2). In another example, the vapor plug 100 may be a stepped or tiered vapor plug that has a neck 104 with a step-like structure or tiered portions, as shown in FIGS. 4A-4B for example, that are inserted into the opening of the dewar 202 (FIG. 2). The different implementations of the neck 104 are further described below.

In various embodiments, as shown in FIGS. 1A-1B and with periodic reference to FIG. 2, the vapor plug 100 may have a neck 104 with a first end 118a and a second end 118b that is tapered. The second end 118b may be angled inward toward the center of the vapor plug 100 and away from the inner surface of the dewar 202 when inserted into the opening of the dewar 202. Since the second end 118b is angled inward, the second diameter 116 and circumference of the second end 118b is less than the first diameter 114 and circumference of the first end 118a. Moreover, due to the tapered second end 118b, a gap 120 is formed between the outer surface of the neck 104 and the inner surface of the dewar 202, as shown in FIG. 2 for example. The size of the gap 120 may be larger and/or increase along the length of the neck 104 toward a distal end of the neck 104. The size of the gap 120 may be larger at the bottom of the second end 118b, which is distal to the opening of the dewar 202 when the vapor plug 100 is inserted into the dewar 202, than at the top of the first end 118a, which is proximal to the opening of the dewar 202 and is coupled to the vapor plug cover 102. Since the gap 120 is larger at the bottom of the second end 118b and greater than the gap between the inner surface of the neck of the dewar 202 and the neck 104 in a straight wall design, there is more clearance between the inner surface of the dewar 202 and the neck 104 of the vapor plug 100. The additional clearance prevents and/or reduces the likelihood that condensation 208 that forms on the inner surface of the dewar 202 and/or the neck 104 of the vapor plug 100 from freezing the vapor plug 100 to the dewar 202.

With reference to FIGS. 4A-4B and periodic reference to FIG. 2, in various embodiments, the vapor plug 100 may have a neck 104 with multiple portions 406a-b including a top portion 406a and a bottom portion 406b. The multiple portions 406a-b may be cylindrically-shaped and/or conic and adjacent to one another to form a step-like or tiered structure.

The top portion 406a may be coupled to the vapor plug cover 102, and the bottom portion 406b may be adjacent to the top portion 406a. The bottom portion 406b may be integrally formed with the top portion 406a and/or may be adhered to, fastened to and/or coupled to the top portion 406a. The bottom portion 406b may be positioned distally away from the vapor plug cover 102 and the opening of the dewar 202 when the vapor plug 100 is inserted into the opening of the dewar 202. The multiple portions 406a-b of the neck 104 may form a tiered or step-like structure where the diameter 404 and/or circumference of the bottom portion 406b is less than the diameter 402 and/or circumference of the top portion 406a. This results in a larger gap 120 (FIG. 2) between the neck 104 and the inner surface of the dewar 202 near the second end 118b of the neck 104 in comparison to the gap 120 between the neck 104 and the inner surface of the dewar 202 near the first end 118a of the neck 104 when the vapor plug 100 is inserted into the opening of the dewar 202. Similarly, since the gap 120 is larger at the bottom of the second end 118b, there is more clearance between inner surface of the dewar 202 and the neck 104 of the vapor plug 100. The additional clearance prevents and/or reduces the likelihood that condensation 208 that forms on the inner surface of the dewar 202 and/or the neck 104 of the vapor plug 100 from freezing the vapor plug 100 to the dewar 202.

Referring to FIGS. 1A-B and 4A-B, the vapor plug 100 may have a liner 108. The liner 108 may be fleece, sleeve or sock that has an opening on a proximal end that is shaped to receive the neck 104 of the vapor plug 100 and closed on the other end that is inserted into the opening of the dewar 202. The liner 108 may be tapered to fit and/or receive the tapered end of the neck 104. For example, the proximal end of the liner 108 with the opening may have a larger cross-sectional circumference and/or diameter than the opposite distal end of the liner 108 that surrounds or encloses the distal end 118b of the neck 104 that is inserted within the opening of the dewar 202. Moreover, the liner 108 may be a hydrophobic liner that repels water vapor, such as condensation or other moisture that may build up on the liner 108. And so, when the neck 104 is inserted into the liner 108 and the liner 108 is snugly fit around the neck 104, the liner 108 protects the neck 104 from the buildup of condensation and/or moisture on the neck 104. Additionally, the liner 108 prevents nitrogen within the payload area of the dewar 202 from escaping the dewar 202.

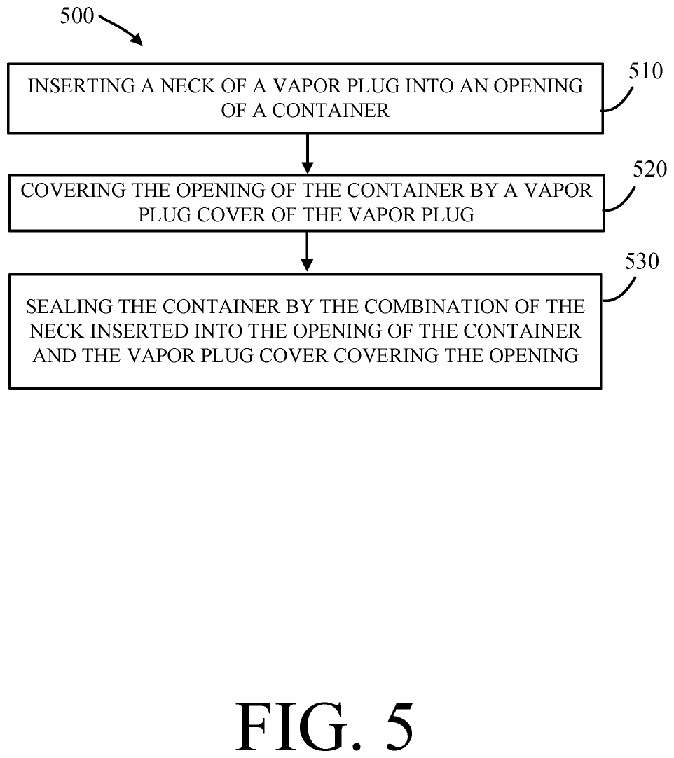

In accordance with various embodiments, with reference to FIG. 5 and continued reference to FIGS. 1-4, a method 500 for sealing a container using a vapor plug is provided. The method 500 may include inserting a neck of a vapor plug into an opening of a container (block 510). The container may be a dewar or other insulated storage container. The neck may be tapered, having a first end and a second end opposite the first end. The second end of the tapered neck may be inserted into the opening of the container. A diameter of the second end (second diameter) may be less than a diameter of the first end (first diameter).

The method may continue with covering the opening of the container by a vapor plug cover or lid adjacent to the first end of the tapered neck (block 520). As the tapered neck is received into the container, the vapor plug cover or lid may be brought near to the opening in response to the inserting, so that vapor plug cover or lid covers the opening.

Finally, the method may include sealing the container by the combination of the tapered neck inserted into the opening of the container and the vapor plug cover or lid near to the opening (block 530).

In various embodiments, the sealing according to block 530 may further include using a hydrophobic liner between the vapor plug and the neck. Moreover, the sealing may include positioning a gasket underneath the vapor plug cover and an O-ring between the gasket and the neck of the of the vapor plug and equalizing the pressure of the container by allowing the gasket and O-ring to be in contact and allow gas or liquid to escape the container thereby sealing the vapor plug cover to the container. Various configurations implemented consistent with various disclosed embodiments may be implemented.

Exemplary embodiments of the methods/systems have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

What is claimed is:

1. A vapor plug, comprising:
a vapor plug cover or lid that is configured to cover an opening of a container; and
a neck having a first end and a second end that is configured to be inserted into the opening of the container, the first end having a first diameter and the second end having a second diameter that is less than the first diameter.

2. The vapor plug of claim 1, wherein the second end is gradually tapered inward toward a center of the neck from the first end which results in the second end having the second diameter that is less than the first diameter.

3. The vapor plug of claim 1, wherein the neck has two or more cylindrical portions including a first cylindrical portion and a second cylindrical portion, wherein the second cylindrical portion is adjacent to the first cylindrical portion to form a step-like or tiered structure.

4. The vapor plug of claim 1, further comprising:
a handle coupled to the neck and configured to allow ease of access to remove or insert the vapor plug into the opening of the container.

5. The vapor plug of claim 4, wherein the handle is configured to be inserted through an opening in the vapor plug cover or lid into an opening or a recess within the neck to couple the handle with the neck.

6. The vapor plug of claim 1, further comprising:
a hydrophobic liner shaped and sized to fit around the neck and configured to receive the neck within, wherein the hydrophobic liner has a first end with a first circumference and a second end with a second circumference, wherein the first circumference of the first end of the hydrophobic liner is greater than a first circumference of the first end of the neck and the second circumference of the second end of the hydrophobic liner is less than the first circumference of the first end of the hydrophobic liner.

7. The vapor plug of claim 1, further comprising:
a gasket positioned underneath the vapor plug cover; and
an O-ring positioned in between the gasket and the neck, the gasket and the O-ring configured to prevent leakage between the vapor plug cover and the neck when joined together.

8. A vapor plug, comprising:
a vapor plug cover that is configured to cover an opening of a container;
a tapered neck having a first end and a second end that is opposite the first end and configured to be inserted into the opening of the container, the first end having a first diameter and the second end having a second diameter that is less than the first diameter; and
a hydrophobic liner shaped and sized to fit around the neck and configured to receive the neck within.

9. The vapor plug of claim 8, wherein there is a first distance between an inner surface of a neck of the container and the first end when the neck is inserted into an opening in the container and a second distance between the inner surface of the neck of the container and the second end when the neck is inserted into the opening in the container.

10. The vapor plug of claim 8, further comprising:
a handle coupled to the neck and configured to allow ease of access to remove or insert the vapor plug into the opening of the container.

11. The vapor plug of claim 10, wherein the handle is configured to be inserted through an opening in the vapor plug cover or lid into an opening or a recess within the neck to couple the handle with the neck.

12. The vapor plug of claim 8, wherein the hydrophobic liner has a first end with a first circumference and a second end with a second circumference, wherein the first circumference of the first end of the hydrophobic liner is greater than a first circumference of the first end of the neck and a second circumference of the second end of the hydrophobic liner is less than the first circumference of the first end of the hydrophobic liner.

13. The vapor plug of claim 8, further comprising:
a gasket positioned underneath the vapor plug cover; and
an O-ring positioned in between the gasket and the neck, the gasket and the O-ring configured to partially seal a cavity of the container while allowing gas or liquid to escape to equalize pressure within the container when the neck of the vapor plug is inserted into an opening of the container.

14. A tapered vapor plug, comprising:
a vapor plug cover that is configured to cover an opening of a dewar; and
a tapered neck having a proximal end coupled to the vapor plug cover and a tapered distal end that is configured to be inserted into the opening of the dewar, the tapered neck having a shape of an inverted frustum of a cone.

15. The tapered vapor plug of claim 14, wherein the proximal end is proximal to the opening of the container and the tapered distal end is opposite the proximal end and distal to the opening of the container when inserted into the opening of the dewar.

16. The tapered vapor plug of claim 14, wherein the proximal end has a first circumference and the distal end has a second circumference that is less than the first circumference.

17. The tapered vapor plug of claim 14, further comprising:
a hydrophobic liner shaped and sized to fit around the neck and configured to receive the neck within.

18. A method for sealing a container using a vapor plug, the method comprising:
inserting a tapered neck of a vapor plug into an opening of a container, the tapered neck having a first end and a second end, the first end having a first diameter and the second end having a second diameter that is less than the first diameter;
covering the opening of the container by a vapor plug cover adjacent to a first end of the vapor plug; and
sealing the container by the combination of the tapered neck inserted into the opening of the container and the vapor plug cover covering the opening.

19. The method of claim 18, wherein sealing the container further comprises receiving between the neck and the opening of the container a hydrophobic liner shaped and sized to fit around the neck.

20. The method of claim 18, wherein sealing the container further comprises positioning a gasket underneath the vapor plug cover and an O-ring between the gasket and the neck of the of the vapor plug.
